(19) United States
(12) Patent Application Publication
(10) Pub. No.: US 2026/0360868 A1
(43) Pub. Date: Nov. 12, 2026

(54) SECONDARY BATTERY AND ELECTRICAL DEVICE

(71) Applicant: Ningde Amperex Technology Limited, Ningde (CN)

(72) Inventors: Jufeng ZHOU, Ningde (CN); Qiaofeng CHEN, Ningde (CN); Guowen ZHANG, Ningde (CN)

(73) Assignee: Ningde Amperex Technology Limited, Ningde (CN)

(21) Appl. No.: 19/674,137

(22) Filed: May 12, 2026

(30) Foreign Application Priority Data
May 12, 2025 (CN) 202510610517.0

(51) Int. Cl. H01M 50/103; H01M 10/0525; H01M 10/0585; H01M 50/119; H01M 50/186

(52) U.S. Cl. CPC H01M 50/103; H01M 10/0525; H01M 10/0585; H01M 50/119; H01M 50/186

(57) ABSTRACT

A secondary battery includes a casing, an electrode assembly, and a sealing element. The casing includes a first casing and a second casing. The first casing includes a first wall and a first sidewall connected to a periphery of the first wall. The second casing includes a second wall and a second sidewall connected to a periphery of the second wall. A first surface facing the second sidewall is provided on the first sidewall, and a second surface facing the first sidewall is provided on the second sidewall. The first surface and the second surface face each other, with a clearance in between. A sum of an area of the first surface and an area of the second surface is greater than a sum of an area of a cross-section of the first sidewall and an area of a cross-section of the second sidewall.

### CROSS-REFERENCE TO RELATED APPLICATION

This application claims priority to the Chinese Patent Application Serial No. 202510610517.0, filed on May 12, 2025, the content of which is incorporated herein by reference in its entirety.

### TECHNICAL FIELD

This application relates to the technical field of energy storage, and in particular, to a secondary battery and an electrical device.

### BACKGROUND

Currently, secondary batteries include steel-cased batteries and pouch batteries. Generally, a steel-cased battery and a pouch battery each include a housing and an electrode assembly accommodated in the housing. The housing of a steel-cased battery includes a first casing and a second casing. The first casing and the second casing are hermetically connected by welding.

### SUMMARY

With respect to secondary batteries in the prior art, the applicant hereof finds that when the first casing and the second casing are electrically connected to different polarities of the electrode assembly respectively, the first casing and the second casing generally need to be separated by an adhesive layer to implement insulation. However, the first casing and the second casing are prone to deform when subjected to an external force, thereby making the sealing interface prone to peel off between the adhesive layer and the first and second casings, and consequently posing a risk of leakage-induced failure of the secondary battery.

In view of the above situation, it is necessary to provide a secondary battery to reduce the risk of leakage-induced failure.

According to a first aspect of this application, a secondary battery is provided, including a housing, an electrode assembly, and a sealing element. The housing includes a first casing and a second casing. The first casing and the second casing together form an accommodation cavity. The accommodation cavity is filled with an electrolyte solution. The first casing includes a first wall and a first sidewall connected to a periphery of the first wall. The second casing includes a second wall and a second sidewall connected to a periphery of the second wall. Along an assembling direction of the first casing and the second casing, the first sidewall and the second sidewall face each other. The first sidewall has a first surface on a side facing away from the first wall, the first surface facing the second sidewall. The second sidewall has a second surface on a side facing away from the second wall, the second surface facing the first sidewall. The first surface and the second surface face each other, with a clearance in between. A sum of an area of the first surface and an area of the second surface is greater than a sum of an area of a cross-section of the first sidewall and an area of a cross-section of the second sidewall. The cross-section of the first sidewall is perpendicular to an extension direction of the first sidewall. The cross-section of the second sidewall is perpendicular to an extension direction of the second sidewall. The electrode assembly is disposed in the accommodation cavity. A negative electrode of the electrode assembly is connected to the first casing, and a positive electrode of the electrode assembly is connected to the second casing. The sealing element is disposed around outer peripheries of the first sidewall and the second sidewall and configured to seal the clearance. The sealing element includes a filler portion that fills the clearance.

The filler portion fills the clearance between the first surface and the second surface, thereby reducing the probability that an electrolyte solution enters the clearance and erodes the sealing interface between the sealing element and the outer peripheries of the first and second sidewalls. Further, because the sum of the areas of the first surface and the second surface is greater than the sum of the cross-sectional areas of the first sidewall and the second sidewall, the sealing strength between the filler portion and the first and second sidewalls can be improved. When the first casing and the second casing are subjected to external forces, this arrangement reduces the probability of peel-off at the sealing interface between the filler portion and the first and second sidewalls, thereby reducing the risk of leakage-induced failure of the secondary battery.

In one or embodiments, the first sidewall includes a first extension portion that protrudes toward the second sidewall. The second sidewall includes a second extension portion that protrudes toward the first sidewall. Along a direction perpendicular to the assembling direction of the first casing and the second casing, the first extension portion and the second extension portion are spaced apart. At least a part of the filler portion fills a gap between the first extension portion and the second extension portion. A surface, facing the filler portion, of the first extension portion constitutes a part of the first surface. A surface, facing the filler portion, of the second extension portion constitutes a part of the second surface. At least a part of the filler portion fills the gap between the first extension portion and the second extension portion, thereby increasing the sealing area between the filler portion and the first and second sidewalls, and improving the sealing strength between the filler portion and the first and second sidewalls. Further, through cooperation between the first extension portion and the second extension portion, the filler portion can be limited along the wall thickness direction of the housing, thereby making the filler portion less prone to peel off from the first sidewall and the second sidewall along the wall thickness direction of the housing.

In one or more embodiments, an angle between the first surface and an outer wall surface of the first sidewall is an obtuse angle, and an angle between the second surface and an inner wall surface of the second sidewall is an obtuse angle; or, an angle between the first surface and an inner wall surface of the first sidewall is an obtuse angle, and an angle between the second surface and an outer wall surface of the second sidewall is an obtuse angle. This increases the sealing area between the filler portion and the first and second sidewalls, and improves the sealing strength between the filler portion and the first and second sidewalls. Further, when a part of the sealing element melts and enters the clearance between the first surface and the second surface and then cools down to form the filler portion, the filler portion can more thoroughly fill the clearance under the action of gravity, thereby further reducing the probability that the filler portion peels off from the first sidewall and the second sidewall, and consequently further reducing the risk of leakage-induced failure of the secondary battery.

In one or more embodiments, the first surface includes a plurality of convex surfaces arranged continuously or discontinuously; and/or, the second surface includes a plurality of convex surfaces arranged continuously or discontinuously. When a part of the sealing element melts and enters the clearance between the first surface and the second surface and then cools down to form the filler portion, this arrangement makes it convenient for the filler portion to fit with the first surface and/or the second surface, and makes the filler portion less prone to peel off from the first sidewall and the second sidewall along the direction perpendicular to the assembling direction of the first casing and the second casing.

In one or more embodiments, viewed from inside the accommodation cavity outward along the direction perpendicular to the assembling direction of the first casing and the second casing, the first extension portion and the second extension portion partially overlap. When the first sidewall or the second sidewall is subjected to an external force, the overlap part between the first extension portion and the second extension portion can form a support, thereby reducing the probability that the first sidewall or the second sidewall is recessed and deformed into the accommodation cavity.

In one or more embodiments, the first casing is a steel casing, and the second casing is an aluminum casing.

In one or more embodiments, a wall thickness of the first sidewall is H₁, and a wall thickness of the second sidewall is H₂, wherein H₂>H₁. When the first casing is a steel casing and the second casing is an aluminum casing, the second sidewall is more prone to deform than the first sidewall under an external force. By setting the wall thickness of the second sidewall to be greater than that of the first sidewall, this application improves the hardness and strength of the second sidewall, and reduces the risk that the second sidewall deforms and peels off from the filler portion.

In one or more embodiments, 10 μm≤H₁≤300 μm, and 100 μm≤H₂≤500 μm. By setting 10 μm≤H₁ and 100 μm≤H₂, this application prevents the wall thickness of the first sidewall and the second sidewall from being excessively small, and ensures that the first sidewall and the second sidewall are of appropriate strength. By setting H₁≤300 μm and H₂≤500 μm, this application prevents the wall thickness of the first sidewall and the second sidewall from being excessively large, thereby reducing the energy density loss of the secondary battery.

In one or more embodiments, 30 μm≤H₁≤200 μm and 150 μm≤H₂≤300 μm. By setting 30 μm≤H₁ and 150 μm≤H₂, this application achieves higher strength of the first sidewall and the second sidewall. By setting H₁≤200 μm and H₂≤300 μm, this application further reduces the energy density loss of the secondary battery.

In one or more embodiments, 10% H₁≤H₂−H₁≤30% H₁. By setting 10% H₁≤H₂−H₁≤30% H₁, when the first casing is a steel casing and the second casing is an aluminum casing, this application reduces the energy density loss of the secondary battery while making the strength of the second sidewall relatively close to the strength of the first sidewall.

In one or more embodiments, the electrode assembly is provided with a negative tab leading out a negative polarity and a positive tab leading out a positive polarity. The negative tab is connected to the first sidewall, and the positive tab is connected to the second sidewall. This facilitates connection of the negative tab to the first casing and connection of the positive tab to the second casing, and improves the ease of preparing the secondary battery. When the first wall and the second wall are disposed opposite to each other along the thickness direction of the secondary battery, the connection of the negative tab to the first sidewall and the connection of the positive tab to the second sidewall also reduce the space occupied by the secondary battery along the thickness direction. Further, the sealing interface between the filler portion and the first and second sidewalls is not prone to peel off. Therefore, the housing is not prone to torsional deformation when the first casing and the second casing are subjected to an external force, thereby improving the stability of the connection between the negative tab and the first sidewall as well as the connection between the positive tab and the second sidewall.

In one or more embodiments, a minimum distance between the first sidewall and the second sidewall is D, wherein 7 μm≤D≤5000 μm. By setting 7 μm≤D, this application prevents the distance between the first sidewall and the second sidewall from being excessively small, thereby reducing the probability of short-circuiting between the first casing and the second casing due to burrs contact. By setting D≤5000 μm, this application prevents the distance between the first sidewall and the second sidewall from being excessively large, thereby reducing the energy density loss of the secondary battery.

In one or more embodiments, 40 μm≤D≤3000 μm. By setting 40 μm≤D, this application further reduces the probability of short-circuiting between the first casing and the second casing due to burrs contact. By setting D≤3000 μm, this application further reduces the energy density loss of the secondary battery.

A second aspect of this application provides an electrical device. The electrical device includes the secondary battery disclosed in the first aspect of this application. The secondary battery is less prone to leakage-induced failure, thereby prolonging the service life of the electrical device.

### BRIEF DESCRIPTION OF DRAWINGS

FIG. 1 is a top view of a secondary battery according to an embodiment of this application;

FIG. 2 is a front view of a secondary battery according to an embodiment of this application;

FIG. 3 is an exploded view of a secondary battery according to an embodiment of this application;

FIG. 4 is a cross-sectional view taken along a section line A-A shown in FIG. 1 according to a first embodiment of this application;

FIG. 5 is a cross-sectional view taken along a section line A-A shown in FIG. 1 according to a second embodiment of this application;

FIG. 6 is a cross-sectional view taken along a section line A-A shown in FIG. 1 according to a third embodiment of this application; and

FIG. 7 is an overall schematic diagram of an electrical device according to an embodiment of this application.

### LIST OF REFERENCE SIGNS

1000. electrical device; 100. secondary battery; 10. housing; 101. accommodation cavity; 11. first casing; 111. first wall; 112. first sidewall; 1121. first surface; 1122. first extension portion; 12. second casing; 121. second wall; 122. second sidewall; 1221. second surface; 1222. second extension portion; 20. electrode assembly; 201. negative tab; 202. positive tab; 21. negative electrode plate; 22. positive electrode plate; 23. separator; 30. sealing element; 301. filler portion; 31. first adhesive layer; 32. metal layer; 33. second adhesive layer; 40. fixing piece.

### DETAILED DESCRIPTION

The following describes the technical solutions in some embodiments of this application with reference to the drawings hereof. Evidently, the described embodiments are merely a part of but not all of the embodiments of this application.

It is noted that a component considered to be “connected to” another component may be directly connected to the other component or may be connected to the other component through an intermediate component. A component considered to be “disposed on” another component may be directly disposed on the other component or may be disposed on the other component through an intermediate component.

Unless otherwise expressly specified, the term “a plurality of” used herein means two or more.

The technical terms “first” and “second” are merely intended to distinguish between different items but not intended to indicate or imply relative importance or implicitly specify the number of the indicated technical features, specific order, or order of precedence.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein includes any and all combinations of one or more relevant items enumerated.

Understandably, in technical solutions of this application, considering the actual process tolerance, when two components are arranged parallel or perpendicular to each other, an angle may exist between the two components, and a measured value of this angle permits a tolerance of ±10% compared to the nominal value of the corresponding angle formed when the two components are arranged parallel or perpendicular.

This application provides a secondary battery. The secondary battery includes a housing, an electrode assembly, and a sealing element. The housing includes a first casing and a second casing. The first casing and the second casing together form an accommodation cavity. The accommodation cavity is filled with an electrolyte solution. The first casing includes a first wall and a first sidewall connected to a periphery of the first wall. The second casing includes a second wall and a second sidewall connected to a periphery of the second wall. Along an assembling direction of the first casing and the second casing, the first sidewall and the second sidewall face each other. The first sidewall has a first surface on a side facing away from the first wall, the first surface facing the second sidewall. The second sidewall has a second surface on a side facing away from the second wall, the second surface facing the first sidewall. The first surface and the second surface face each other, with a clearance in between. A sum of an area of the first surface and an area of the second surface is greater than a sum of an area of a cross-section of the first sidewall and an area of a cross-section of the second sidewall. The cross-section of the first sidewall is perpendicular to an extension direction of the first sidewall. The cross-section of the second sidewall is perpendicular to an extension direction of the second sidewall. The electrode assembly is disposed in the accommodation cavity. A negative electrode of the electrode assembly is connected to the first casing, and a positive electrode of the electrode assembly is connected to the second casing. The sealing element is disposed around outer peripheries of the first sidewall and the second sidewall and configured to seal the clearance. The sealing element includes a filler portion that fills the clearance.

In the secondary battery of this application, the filler portion fills the clearance between the first surface and the second surface, thereby reducing the probability that an electrolyte solution enters the clearance and erodes the sealing interface between the sealing element and the outer peripheries of the first and second sidewalls. Further, because the sum of the areas of the first surface and the second surface is greater than the sum of the cross-sectional areas of the first sidewall and the second sidewall, the sealing strength between the filler portion and the first and second sidewalls can be improved. When the first casing and the second casing are subjected to external forces, this arrangement reduces the probability of peel-off at the sealing interface between the filler portion and the first and second sidewalls, thereby reducing the risk of leakage-induced failure of the secondary battery.

The following describes some embodiments of this application with reference to drawings. To the extent that no conflict occurs, the following embodiments and the features in the embodiments may be combined with each other.

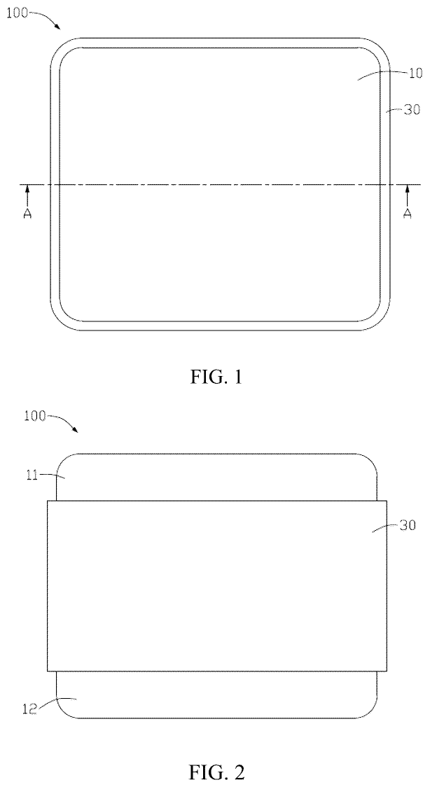

Referring to FIG. 1 to FIG. 4, an embodiment of this application provides a secondary battery 100. The secondary battery includes a housing 10, an electrode assembly 20, and a sealing element 30. The electrode assembly 20 is accommodated in the housing 10. The sealing element 30 is disposed on an outer wall of the housing 10, and is configured to seal the housing 10.

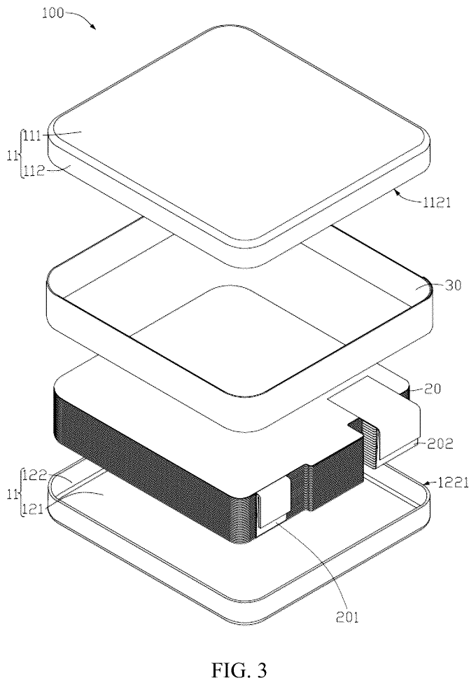

The housing 10 includes a first casing 11 and a second casing 12. The first casing 11 and the second casing 12 together form an accommodation cavity 101. The accommodation cavity 101 is filled with an electrolyte solution. Referring to FIG. 3, the first casing 11 includes a first wall 111 and a first sidewall 112. The second casing 12 includes a second wall 121 and a second sidewall 122. The first sidewall 112 is connected to the periphery of the first wall 111, and the second sidewall 122 is connected to the periphery of the second wall 121. The first sidewall 112 may be inclined or perpendicular to the first wall 111, and the second sidewall 122 may be inclined or perpendicular to the second wall 121, without being limited herein. The first sidewall 112 has a first surface 1121 on a side facing away from the first wall 111, the first surface 1121 facing the second sidewall 122. The second sidewall 122 has a second surface 1221 on a side facing away from the second wall 121, the second surface 1221 facing the first sidewall 112. The first surface 1121 and the second surface 1221 face each other, with a clearance in between. A sum of an area of the first surface 1121 and an area of the second surface 1221 is greater than a sum of an area of a cross-section of the first sidewall 112 and an area of a cross-section of the second sidewall 122. The cross-section of the first sidewall 112 is perpendicular to an extension direction of the first sidewall 112. The cross-section of the second sidewall 122 is perpendicular to an extension direction of the second sidewall 122. The extension direction of the first sidewall 112 refers to a direction extending away from a junction between the first sidewall 112 and the periphery of the first wall 111. The extension direction of the second sidewall 122 refers to a direction extending away from a junction between the second sidewall 122 and the periphery of the second wall 121. The first surface 1121 and the second surface 1221 may be, but are not limited to, planes and curved surfaces.

The electrode assembly 20 is disposed in the accommodation cavity 101. A negative electrode of the electrode assembly 20 is connected to the first casing 11, and a positive electrode of the electrode assembly 20 is connected to the second casing 12. The sealing element 30 is disposed around outer peripheries of the first sidewall 112 and the second sidewall 122 and configured to seal the clearance. The sealing element 30 includes a filler portion 301 that fills the clearance. The filler portion 301 may be formed by melting a part of the sealing element 30, leaving the melted sealing element to enter the clearance between the first surface 1121 and the second surface 1221, and cooling the melted sealing element. The filler portion 301 is in contact with and connected to the first sidewall 112 and the second sidewall 122. The filler portion 301 fills the clearance between the first surface 1121 and the second surface 1221, thereby reducing the probability that an electrolyte solution enters the clearance and erodes the sealing interface between the sealing element 30 and the outer peripheries of the first sidewall 112 and the second sidewall 122. Further, because the sum of the areas of the first surface 1121 and the second surface 1221 is greater than the sum of the cross-sectional areas of the first sidewall 112 and the second sidewall 122, the sealing strength between the filler portion 301 and the first sidewall 112 and the second sidewall 122 can be improved. When the first casing 11 and the second casing 12 are subjected to external forces, this arrangement reduces the probability of peel-off at the sealing interface between the filler portion 301 and the first sidewall 112 and the second sidewall 122, thereby reducing the risk of leakage-induced failure of the secondary battery 100.

In some embodiments, the housing 10 is a metal housing. The material of the first casing 11 may be the same as or different from the material of the second casing 12. In some embodiments, the first casing 11 is a steel casing, and the second casing 12 is an aluminum casing. In some embodiments, the first casing 11 is insulated from the second casing 12 by the filler portion 301.

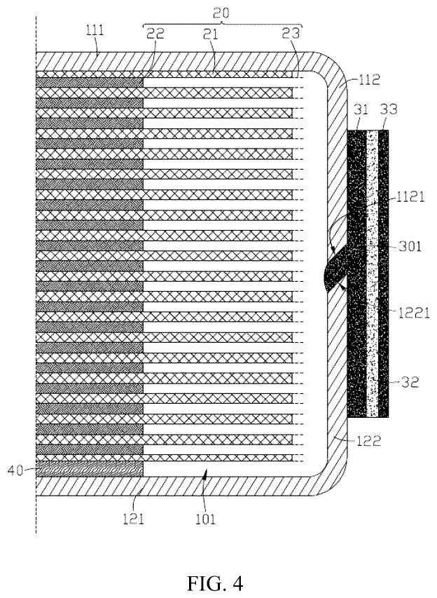

Referring to FIG. 4, in some embodiments, an angle between the first surface 1121 and an outer wall surface of the first sidewall 112 is an obtuse angle, and an angle between the second surface 1221 and an inner wall surface of the second sidewall 122 is an obtuse angle. In some embodiments, an angle between the first surface 1121 and an inner wall surface of the first sidewall 112 is an obtuse angle, and an angle between the second surface 1221 and an outer wall surface of the second sidewall 122 is an obtuse angle. This increases the sealing area between the filler portion 301 and the first sidewall 112 and the second sidewall 122, and improves the sealing strength between the filler portion 301 and the first sidewall 112 and the second sidewall 122. Further, when a part of the sealing element 30 melts and enters the clearance between the first surface 1121 and the second surface 1221 and then cools down to form the filler portion 301, the filler portion 301 can more thoroughly fill the clearance under the action of gravity, thereby further reducing the probability that the filler portion 301 peels off from the first sidewall 112 and the second sidewall 122, and consequently further reducing the risk of leakage-induced failure of the secondary battery 100.

In some embodiments, the distance between the first surface 1121 and the second surface 1221 gradually increases from inside the accommodation cavity 101 toward the exterior of the accommodation cavity 101. In other words, from inside the accommodation cavity 101 toward the exterior of the accommodation cavity 101, the first surface 1121 and the second surface 1221 together form a flared structure.

Understandably, in order to make a part of the sealing element 30 more thoroughly fill the clearance under gravity when this part of sealing element 30 forms the filler portion 301 by melting and cooling, if the angle between the first surface 1121 and the outer wall surface of the first sidewall 112 is obtuse, and the angle between the second surface 1221 and the inner wall surface of the second sidewall 122 is obtuse, then during formation of the filler portion 301, the first casing 11 is configured to be located above the second casing 12 along the direction of gravity; if the angle between the first surface 1121 and the inner wall surface of the first sidewall 112 is obtuse, and the angle between the second surface 1221 and the outer wall surface of the second sidewall 122 is obtuse, then during formation of the filler portion 301, the second casing 12 is configured to be located above the first casing 11 along the direction of gravity.

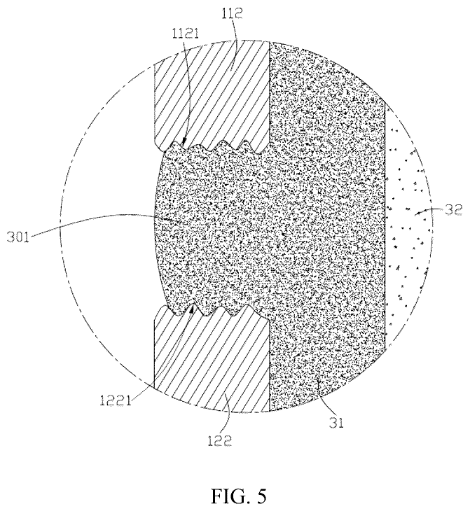

Referring to FIG. 5, in some embodiments, the first surface 1121 includes a plurality of convex surfaces arranged continuously or discontinuously; The continuous arrangement here means that the plurality of convex surfaces of the first surface 1121 are sequentially connected, making the first surface 1121 assume a continuously undulating wave shape. The discontinuous arrangement here means that a plane is provided between two adjacent convex surfaces of the first surface 1121. When a part of the sealing element 30 melts and enters the clearance between the first surface 1121 and the second surface 1221 and then cools down to form the filler portion 301, this arrangement makes it convenient for the filler portion 301 to fit with the first surface 1121, and makes the filler portion 301 less prone to peel off from the first sidewall 112 and the second sidewall 122 along the direction perpendicular to the assembling direction of the first casing 11 and the second casing 12.

Referring to FIG. 5, in some embodiments, the second surface 1221 includes a plurality of convex surfaces arranged continuously or discontinuously; The continuous arrangement here means that the plurality of convex surfaces of the second surface 1221 are sequentially connected, making the second surface 1221 assume a continuously undulating wave shape. The discontinuous arrangement here means that a plane is provided between two adjacent convex surfaces of the second surface 1221. When a part of the sealing element 30 melts and enters the clearance between the first surface 1121 and the second surface 1221 and then cools down to form the filler portion 301, this arrangement makes it convenient for the filler portion 301 to fit with the second surface 1221, and makes the filler portion 301 less prone to peel off from the first sidewall 112 and the second sidewall 122 along the direction perpendicular to the assembling direction of the first casing 11 and the second casing 12.

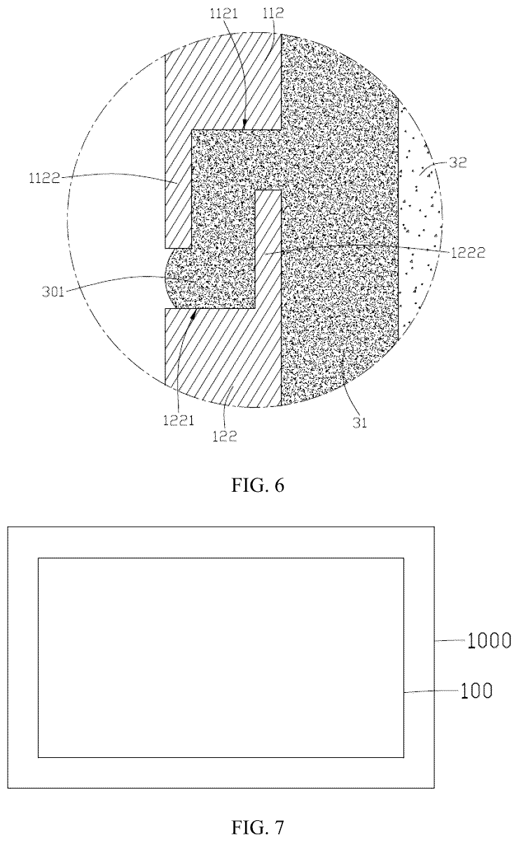

Referring to FIG. 6, in some embodiments, the first sidewall 112 includes a first extension portion 1122. The first extension portion 1122 protrudes toward the second sidewall 122. The second sidewall 122 includes a second extension portion 1222. The second extension portion 1222 protrudes toward the first sidewall 112. Along a direction perpendicular to the assembling direction of the first casing 11 and the second casing 12, the first extension portion 1122 and the second extension portion 1222 are spaced apart. At least a part of the filler portion 301 fills a gap between the first extension portion 1122 and the second extension portion 1222. A surface, facing the filler portion 301, of the first extension portion 1122 constitutes a part of the first surface 1121. A surface, facing the filler portion 301, of the second extension portion 1222 constitutes a part of the second surface 1221. At least a part of the filler portion 301 fills the gap between the first extension portion 1122 and the second extension portion 1222, thereby increasing the sealing area between the filler portion 301 and the first sidewall 112 and the second sidewall 122, and improving the sealing strength between the filler portion 301 and the first sidewall 112 and the second sidewall 122. Further, through cooperation between the first extension portion 1122 and the second extension portion 1222, the filler portion 301 can be limited along the wall thickness direction of the housing 10, thereby making the filler portion 301 less prone to peel off from the first sidewall 112 and the second sidewall 122 along the wall thickness direction of the housing 10.

Referring to FIG. 6, in some embodiments, viewed from inside the accommodation cavity 101 outward along the direction perpendicular to the assembling direction of the first casing 11 and the second casing 12, the first extension portion 1122 and the second extension portion 1222 partially overlap. When the first sidewall 112 or the second sidewall 122 is subjected to an external force, the overlap part between the first extension portion 1122 and the second extension portion 1222 can form a support, thereby reducing the probability that the first sidewall 112 or the second sidewall 122 is recessed and deformed into the accommodation cavity 101.

In some embodiments, a wall thickness of the first sidewall 112 is H₁, and a wall thickness of the second sidewall 122 is H₂, wherein H₂ >H₁. When the first casing 11 is a steel casing and the second casing 12 is an aluminum casing, the second sidewall 122 is more prone to deform than the first sidewall 112 under an external force. By setting the wall thickness of the second sidewall 122 to be greater than that of the first sidewall 112, this application improves the hardness and strength of the second sidewall 122, and reduces the risk that the second sidewall 122 deforms and peels off from the filler portion 301.

In some embodiments, 10 μm≤H₁≤300 μm, and 100 μm≤H₂≤500 μm. For example, the value of H₁ is 10 μm, 20 μm, 30 μm, 50 μm, 100 μm, 200 μm, 300 μm, or a value falling within a range formed by any two thereof; and the value of H₂ is 100 μm, 150 μm, 200 μm, 250 μm, 300 μm, 350 μm, 400 μm, 450 μm, 500 μm, or a value falling within a range formed by any two thereof. By setting 10 μm≤H₁ and 100 μm≤H₂, this application prevents the wall thickness of the first sidewall 112 and the second sidewall 122 from being excessively small, and ensures that the first sidewall 112 and the second sidewall 122 are of appropriate strength. By setting H₁≤300μm and H₂≤500μm, this application prevents the wall thickness of the first sidewall 112 and the second sidewall 122 from being excessively large, thereby reducing the energy density loss of the secondary battery 100.

In some embodiments, 30 μm≤H₁≤200 μm, and 150 μm≤H₂≤300 μm. By setting 30 μm≤H₁ and 150 μm≤H₂, this application achieves higher strength of the first sidewall 112 and the second sidewall 122. By setting H₁≤200 μm and H₂≤300 μm, this application further reduces the energy density loss of the secondary battery 100.

In some embodiments, 10% H₁≤H₂−H₁≤30%H ₁. For example, the value of H₂−H₁ is 10% H₁, 20% H₁, 30% H₁, or a value falling within a range formed by any two thereof. By setting 10% H₁≤H₂−H₁≤30% H₁, when the first casing 11 is a steel casing and the second casing 12 is an aluminum casing, this application reduces the energy density loss of the secondary battery 100 while making the strength of the second sidewall 122 relatively close to the strength of the first sidewall 112.

In some embodiments, a minimum distance between the first sidewall 112 and the second sidewall 122 is D, wherein 7 μm≤D≤5000 μm. For example, the value of D is 7 μm, 10 μm, 20 μm, 40 μm, 100 μm, 200 μm, 500 μm, 1000 μm, 2000 μm, 3000 μm, 5000 μm, or a value falling within a range formed by any two thereof. By setting 7 μm≤D, this application prevents the distance between the first sidewall 112 and the second sidewall 122 from being excessively small, thereby reducing the probability of short-circuiting between the first casing 11 and the second casing 12 due to burrs contact. By setting D≤5000 μm, this application prevents the distance between the first sidewall 112 and the second sidewall 122 from being excessively large, thereby reducing the energy density loss of the secondary battery 100. Understandably, when the first sidewall 112 is provided with a first extension portion 1122 and the second sidewall 122 is provided with a second extension portion 1222, the minimum distance between the first sidewall 112 and the second sidewall 122 refers to the smaller of the distance between the first extension portion 1122 and the second surface 1221, the distance between the second extension portion 1222 and the first surface 1121, and the distance between the first extension portion 1122 and the second extension portion 1222.

In some embodiments, 40μm≤D≤3000 μm. By setting 40 μm≤D, this application further reduces the probability of short-circuiting between the first casing 11 and the second casing 12 due to burrs contact. By setting D≤3000 μm, this application further reduces the energy density loss of the secondary battery 100.

Referring to FIG. 3, in some embodiments, the electrode assembly 20 includes a negative electrode plate 21, a positive electrode plate 22, and a separator 23. The separator 23 separates the negative electrode plate 21 from the positive electrode plate 22. In some embodiments, the electrode assembly 20 assumes a stacked structure, in which a plurality of negative electrode plates 21 and a plurality of positive electrode plate 22 are alternately stacked, and the separator 23 is disposed between any adjacent negative electrode plate 21 and positive electrode plate 22. In some embodiments, the electrode assembly 20 assumes a wound structure, in which a single negative electrode plate 21 and a single positive electrode plate 22 are stacked and then wound together, and the separator 23 is disposed between the negative electrode plate 21 and the positive electrode plate 22.

In some embodiments, the negative electrode plate 21 includes a negative current collector and a negative active material layer. The negative active material layer is disposed on two surfaces of the negative current collector, the two surfaces being opposite to each other along the thickness direction of the current collector. The positive electrode plate 22 includes a positive current collector and a positive active material layer. The positive active material layer is disposed on two surfaces of the positive current collector, the two surfaces being opposite to each other along the thickness direction of the current collector. In some embodiments, the negative current collector is made of a material including at least one of copper, nickel, tantalum, or titanium; and the positive current collector is made of a material including at least one of aluminum, nickel, tantalum, or titanium. In some embodiments, the negative active material layer is made of a material including at least one of graphite, hard carbon, soft carbon, silicon, a silicon oxygen compound, or a silicon carbon compound. The positive active material layer is made of a material including at least one of lithium cobalt oxide, lithium nickel cobalt manganese oxide, lithium nickel cobalt aluminum oxide, lithium iron phosphate, lithium manganese iron phosphate, or lithium manganese oxide.

In some embodiments, the separator 23 is an insulating film such as a polyethylene film, a polypropylene film, a polyester film, or a polyimide film.

In some embodiments, when the negative electrode plate 21 is an outermost electrode plate of the electrode assembly 20, the negative current collector is provided with a blank foil region on a surface facing away from the interior of the electrode assembly 20. The negative current collector is in direct contact and connection with the first wall 111 through the blank foil region. When the positive electrode plate 22 is an outermost electrode plate of the electrode assembly 20, the positive current collector is provided with a blank foil region on a surface facing away from the interior of the electrode assembly 20. The positive current collector is in direct contact and connection with the second wall 121 through the blank foil region. Understandably, when the electrode assembly 20 assumes a stacked structure, the outermost electrode plate is an electrode closest to the first wall 111 or the second wall 121 among a plurality of electrode plates of the electrode assembly 20 along the thickness direction of the electrode assembly 20. When the electrode assembly 20 assumes a wound structure, the outermost electrode plate is a flat region of the outermost wound electrode plate, the region being located between bent regions and close to the first wall 111 or the second wall 121.

Referring to FIG. 3, in some embodiments, the electrode assembly 20 is provided with a negative tab 201 leading out a negative polarity, and a positive tab 202 leading out a positive polarity. The negative tab 201 is connected to the first sidewall 112, and the positive tab 202 is connected to the second sidewall 122. This facilitates connection of the negative tab 201 to the first casing 11 and connection of the positive tab 202 to the second casing 12, and improves the ease of preparing the secondary battery 100. When the first wall 111 and the second wall 121 are disposed opposite to each other along the thickness direction of the secondary battery 100, the connection of the negative tab 201 to the first sidewall 112 and the connection of the positive tab 202 to the second sidewall 122 also reduce the space occupied by the secondary battery 100 along the thickness direction. Further, the sealing interface between the filler portion 301 and the first sidewall 112 and the second sidewall 122 is not prone to peel off. Therefore, the housing 10 is not prone to torsional deformation when the first casing 11 and the second casing 12 are subjected to an external force, thereby improving the stability of the connection between the negative tab 201 and the first sidewall 112 as well as the connection between the positive tab 202 and the second sidewall 122. In some embodiments, a plurality of negative tabs 201 are converged to form a negative tab bundle. A plurality of positive tabs 202 are converged to form a positive tab bundle. The negative tab bundle is in direct contact with and connected to the first casing 11, and the positive tab bundle is in direct contact with and connected to the second casing 12.

Referring to FIG. 4, in some embodiments, the sealing element 30 includes a first adhesive layer 31. The first adhesive layer 31 is adhered to the outer peripheries of the first sidewall 112 and the second sidewall 122. The filler portion 301 is connected to the first adhesive layer 31. The adhesion of the first adhesive layer 31 to the first sidewall 112 and the second sidewall 122 improves the stability of the bond between the sealing element 30 and the housing 10.

In some embodiments, the filler portion 301 is integrally formed with the first adhesive layer 31. The filler portion 301 may be directly formed by a part of the first adhesive layer 31 that is cooled after melting and entering the clearance between the first surface 1121 and the second surface 1221. This simplifies the assembling process of the secondary battery 100, and streamlines the manufacturing process of the secondary battery 100. Further, by being integrally formed with the first adhesive layer 31, the filler portion 301 can thoroughly fit with the clearance between the first surface 1121 and the second surface 1221, thereby improving the hermeticity of the sealing element 30 for the first casing 11 and the second casing 12. In other embodiments, the filler portion 301 is disposed separate from the first adhesive layer 31.

In some embodiments, the first adhesive layer 31 is capable of melting or losing adhesion upon heating, and forms a part of a pressure-relief channel in communication with the accommodation cavity 101. When the secondary battery 100 is thermally runaway, the first adhesive layer 31 melts or loses adhesion to promptly relieve pressure in the accommodation cavity 101, thereby improving the safety of the secondary battery 100.

In some embodiments, the melting point of the first adhesive layer 31 is 95° C. to 130° C. For example, the melting point of the first adhesive layer 31 is 95° C., 100° C., 110° C., 130° C., or a value falling within a range formed by any two thereof. By setting the melting point of the first adhesive layer 31 to be 95° C. to 130° C., this application reduces the probability of premature melting or adhesion loss of the first adhesive layer 31 before thermal runaway of the secondary battery 100, thereby maintaining good sealing effect of the sealing element 30 on the housing 10. In addition, this setting ensures that, in the case of thermal runaway of the secondary battery 100, the first adhesive layer 31 promptly melts or loses adhesion to relieve pressure in the accommodation cavity 101, thereby improving the safety of the secondary battery 100.

Understandably, in the case that the filler portion 301 is integrally formed with the first adhesive layer 31, when the filler portion 301 is directly formed by a part of the first adhesive layer 31 that is cooled after melting and entering the clearance between the first surface 1121 and the second surface 1221, the melting point of the filler portion 301 is substantially identical to the melting point of the first adhesive layer 31. The melting point of the filler portion 301 is 95° C. to 130° C. By setting the melting point of the filler portion 301 to be 95° C. to 130° C., this application reduces the probability of premature melting of the filler portion 301 before thermal runaway of the secondary battery 100, thereby maintaining good sealing effect of the sealing element 30 on the housing 10. In addition, this setting ensures that, in the case of thermal runaway of the secondary battery 100, the filler portion 301 promptly melts to relieve pressure in the accommodation cavity 101, thereby improving the safety of the secondary battery 100.

In some embodiments, the first adhesive layer 31 is made of a material including an electrolyte-resistant polymer. The polymer includes at least one of polyolefin, fluororubber, or polyurethane. The polyolefin may include polypropylene, polyethylene, and the like. Accordingly, the first adhesive layer 31 exhibits relatively high resistance to electrolyte corrosion. In some embodiments, the first adhesive layer 31 includes a single-layer or multi-layer polymer.

Referring to FIG. 4, in some embodiments, the sealing element 30 includes a metal layer 32. The metal layer 32 is disposed on the first adhesive layer 31 on a side facing away from the housing 10. The water-blocking properties of the metal layer 32 are superior to those of the first adhesive layer 31, thereby improving the ability of the sealing element 30 to seal the first casing 11 and the second casing 12.

In some embodiments, the metal layer 32 is made of a material including at least one of steel, aluminum, nickel, silver, copper, or an alloy thereof. In some embodiments, the metal layer 32 is a single-layer or multi-layer structure. For example, the multi-layer structure may be a steel layer plus an aluminum layer or a nickel layer plus a copper layer.

Referring to FIG. 4, in some embodiments, the sealing element 30 includes a second adhesive layer 33. The second adhesive layer 33 is disposed on the metal layer 32 on a side facing away from the first adhesive layer 31. The second adhesive layer 33 can protect the metal layer 32, thereby reducing the risk of breakage and failure of the metal layer 32.

In some embodiments, the melting point of the second adhesive layer 33 is higher than that of the first adhesive layer 31. In some embodiments, the melting point difference between the second adhesive layer 33 and the first adhesive layer 31 is 10° C. or more.

In some embodiments, the melting point of the second adhesive layer 33 is 140° C. to 500° C. For example, the melting point of the second adhesive layer 33 is 140° C., 160° C., 200° C., 250° C., 300° C., 500° C., or a value falling within a range formed by any two thereof.

In some embodiments, the second adhesive layer 33 is made of a material including an electrolyte-resistant polymer. The polymer includes at least one of polyolefin, fluoropolymer, polyether ether ketone, fluororubber, or polyurethane. The polyolefin may include polypropylene, polyethylene, and the like. The fluoropolymer may be polytetrafluoroethylene or the like. Accordingly, the second adhesive layer 33 exhibits relatively high resistance to electrolyte corrosion. In some embodiments, the second adhesive layer 33 includes a single-layer or multi-layer polymer.

Understandably, when the sealing element 30 includes the first adhesive layer 31, the metal layer 32, and the second adhesive layer 33 concurrently, the first adhesive layer 31 and the second adhesive layer 33 are disposed on two sides of the metal layer 32 respectively along the thickness direction of the metal layer 32. In some embodiments, the first adhesive layer 31 is adhesively fixed to the metal layer 32, and the second adhesive layer 33 is adhesively fixed to the metal layer 32, such that the first adhesive layer 31, the metal layer 32, and the second adhesive layer 33 are combined into a whole. In some embodiments, the first adhesive layer 31 is fixed to the metal layer 32 by hot pressing, and the second adhesive layer 33 is fixed to the metal layer 32 by hot pressing, such that the first adhesive layer 31, the metal layer 32, and the second adhesive layer 33 are combined into a whole. During the long-term use of the secondary battery 100, the above arrangement is beneficial to maintaining the ability of the sealing element 30 to seal the first casing 11 and the second casing 12.

In some embodiments, along the thickness direction of the sealing element 30, the thickness of the first adhesive layer 31 is d₁, the thickness of the metal layer 32 is d₂, and the thickness of the second adhesive layer 33 is d₃, wherein 7 μm≤d₁≤500 μm, 7 μm≤d₂≤250 μm, and 6 μm≤d₃≤500 μm. For example, d₁ is 7 μm, 10 μm, 20 μm, 50 μm, 100 μm, 200 μm, 500 μm, or a value falling within a range formed by any two thereof; d₂ is 7 μm, 10 μm, 20 μm, 50 μm, 100 μm, 150 μm, 250 μm, or a value falling within a range formed by any two thereof; and d₃ is 6 μm, 8 μm, 20 μm, 50 μm, 100 μm, 200 μm, 500 μm, or a value falling within a range formed by any two thereof. By setting 7 μm≤d₁, 7 μm≤d₂, and 6 μm≤d₃, this application prevents the first adhesive layer 31, the metal layer 32, and the second adhesive layer 33 from being excessively thin, thereby reducing the risk of failure of the first adhesive layer 31 after being corroded by the electrolyte solution, and reducing the risk that the metal layer 32 fails due to breakage or the metal layer 32 fails due to erosion after the second adhesive layer 33 is broken by a drop of the secondary battery 100. By setting d₁≤500 μm, d₂≤250 μm, and d₃≤500 μm, this application prevents the first adhesive layer 31, the metal layer 32, and the second adhesive layer 33 from being excessively thick, thereby increasing the energy density of the secondary battery 100.

In some embodiments, 10 μm≤d₁≤200μm, 10 μm≤d₂≤150 μm, and 8 μm≤d₃≤200 μm. By setting 10 μm≤d₁, 10 μm≤d₂, and 8 μm≤d₃, this application makes the first adhesive layer 31, the metal layer 32, and the second adhesive layer 33 thicker, thereby further reducing the risk of failure of the first adhesive layer 31 after being corroded by the electrolyte solution, and further reducing the risk that the metal layer 32 fails due to breakage or the metal layer 32 fails due to erosion after the second adhesive layer 33 is broken by a drop of the secondary battery 100. By setting d₁≤200 μm, d₂≤150 μm, and d₃≤200 μm, this application further increases the energy density of the secondary battery 100 while ensuring that the thickness of the first adhesive layer 31 is basically sufficient to prevent failure caused by electrolyte corrosion, and that the thickness of the second adhesive layer 33 is sufficient to survive most drop scenarios, and that the thickness of the metal layer 32 is basically sufficient to prevent failure caused by breakage or erosion.

In some embodiments, the thickness of the first adhesive layer 31 may be uniform or non-uniform. In some embodiments, the thickness of the metal layer 32 may be uniform or non-uniform. In some embodiments, the thickness of the second adhesive layer 33 may be uniform or non-uniform. In some embodiments, the thickness of the sealing element 30 may be uniform or non-uniform, and the thickness of the sealing element 30 is equal to the sum of the thicknesses of the first adhesive layer 31, the metal layer 32, and the second adhesive layer 33.

Referring to FIG. 4, in some embodiments, the secondary battery 100 further includes a fixing piece 40. The fixing piece 40 is configured to affix the housing 10 to the electrode assembly 20. This reduces the risk that the first casing 11 and/or the second casing 12 is detached from the sealing element 30 due to wobbling of the electrode assembly 20 in the accommodation cavity 101. In some embodiments, the fixing piece 40 is disposed between the housing 10 and the electrode assembly 20 along the thickness direction of the electrode assembly 20. In some embodiments, the fixing piece 40 is a hot-melt adhesive.

Referring to FIG. 7, an embodiment of this application provides an electrical device 1000, including the above-mentioned secondary battery 100. The secondary battery 100 is less prone to leakage-induced failure, thereby prolonging the service life of the electrical device 1000. The electrical device 1000 includes, but is not limited to, electronic devices such as an e-book player, a mobile phone, a fax machine, a photocopier, a printer, a headphone, a video recorder, an LCD TV, an audio recorder, a radio, a camera, a tablet, and a laptop.

In addition, a person of ordinary skill in the art understands that the foregoing embodiments are merely intended to illustrate this application, but not to limit this application. Any and all appropriate modifications and changes made to the embodiments without departing from the essence of this application still fall within the protection scope of this application.

What is claimed is:

1. A secondary battery, wherein the secondary battery comprises:
a housing, comprising a first casing and a second casing, wherein the first casing and the second casing together form an accommodation cavity, and the accommodation cavity is filled with an electrolyte solution; the first casing comprises a first wall and a first sidewall connected to a periphery of the first wall; the second casing comprises a second wall and a second sidewall connected to a periphery of the second wall; along an assembling direction of the first casing and the second casing, the first sidewall and the second sidewall face each other; the first sidewall has a first surface on a side facing away from the first wall, the first surface facing the second sidewall; the second sidewall has a second surface on a side facing away from the second wall, the second surface facing the first sidewall; the first surface and the second surface face each other, with a clearance in between; a sum of an area of the first surface and an area of the second surface is greater than a sum of an area of a cross-section of the first sidewall and an area of a cross-section of the second sidewall; the cross-section of the first sidewall is perpendicular to an extension direction of the first sidewall; and the cross-section of the second sidewall is perpendicular to an extension direction of the second sidewall;
an electrode assembly, disposed in the accommodation cavity, wherein a negative electrode of the electrode assembly is connected to the first casing, and a positive electrode of the electrode assembly is connected to the second casing; and
a sealing element, disposed around outer peripheries of the first sidewall and the second sidewall to seal the clearance, wherein the sealing element comprises a filler portion that fills the clearance.

2. The secondary battery according to claim 1, wherein the first sidewall comprises a first extension portion and the first extension portion protrudes toward the second sidewall; the second sidewall comprises a second extension portion and the second extension portion protrudes toward the first sidewall; along a direction perpendicular to the assembling direction of the first casing and the second casing, the first extension portion and the second extension portion are spaced apart; and at least a part of the filler portion fills a gap between the first extension portion and the second extension portion; and
a surface of the first extension portion facing the filler portion, constitutes a part of the first surface, and a surface of the second extension portion facing the filler portion, constitutes a part of the second surface.

3. The secondary battery according to claim 1, wherein an angle between the first surface and an outer wall surface of the first sidewall is an obtuse angle, and an angle between the second surface and an inner wall surface of the second sidewall is an obtuse angle; or, an angle between the first surface and an inner wall surface of the first sidewall is an obtuse angle, and an angle between the second surface and an outer wall surface of the second sidewall is an obtuse angle.

4. The secondary battery according to claim 1, wherein the first surface comprises a plurality of convex surfaces arranged continuously or discontinuously; and/or, the second surface comprises a plurality of convex surfaces arranged continuously or discontinuously.

5. The secondary battery according to claim 2, wherein viewed from inside the accommodation cavity outward along the direction perpendicular to the assembling direction of the first casing and the second casing, the first extension portion and the second extension portion partially overlap.

6. The secondary battery according to claim 1, wherein the first casing is a steel casing, and the second casing is an aluminum casing.

7. The secondary battery according to claim 6, wherein a wall thickness of the first sidewall is H₁, and a wall thickness of the second sidewall is H₂, wherein H₂>H₁.

8. The secondary battery according to claim 7, wherein 10 μm≤H₁≤300 μm, and 100 μm≤H₂≤500 μm.

9. The secondary battery according to claim 8, wherein 30 μm≤H₁≤200 μm, and 150 μm≤H₂≤300 μm.

10. The secondary battery according to claim 8, wherein 10% H₁≤H₂−H₁≤30% H₁.

11. The secondary battery according to claim 1, wherein the electrode assembly is provided with a negative tab leading out a negative polarity and a positive tab leading out a positive polarity, the negative tab is connected to the first sidewall, and the positive tab is connected to the second sidewall.

12. The secondary battery according to claim 1, wherein a minimum distance between the first sidewall and the second sidewall is D, wherein 7 μm≤D≤5000 μm.

13. The secondary battery according to claim 12, wherein 40 μm≤D≤3000μm.

14. An electrical device, wherein the electrical device comprises a secondary battery, and the secondary battery comprises:
a housing, comprising a first casing and a second casing, wherein the first casing and the second casing together form an accommodation cavity, and the accommodation cavity is filled with an electrolyte solution; the first casing comprises a first wall and a first sidewall connected to a periphery of the first wall; the second casing comprises a second wall and a second sidewall connected to a periphery of the second wall; along an assembling direction of the first casing and the second casing, the first sidewall and the second sidewall face each other; the first sidewall has a first surface on a side facing away from the first wall, the first surface facing the second sidewall; the second sidewall has a second surface on a side facing away from the second wall, the second surface facing the first sidewall; the first surface and the second surface face each other, with a clearance in between; a sum of an area of the first surface and an area of the second surface is greater than a sum of an area of a cross-section of the first sidewall and an area of a cross-section of the second sidewall; the cross-section of the first sidewall is perpendicular to an extension direction of the first sidewall; and the cross-section of the second sidewall is perpendicular to an extension direction of the second sidewall;
an electrode assembly, disposed in the accommodation cavity, wherein a negative electrode of the electrode assembly is connected to the first casing, and a positive electrode of the electrode assembly is connected to the second casing; and
a sealing element, disposed around outer peripheries of the first sidewall and the second sidewall to seal the clearance, wherein the sealing element comprises a filler portion that fills the clearance.

15. The electrical device according to claim 14, wherein the first sidewall comprises a first extension portion and the first extension portion protrudes toward the second sidewall; the second sidewall comprises a second extension portion and the second extension portion protrudes toward the first sidewall; along a direction perpendicular to the assembling direction of the first casing and the second casing, the first extension portion and the second extension portion are spaced apart; and at least a part of the filler portion fills a gap between the first extension portion and the second extension portion; and
a surface of the first extension portion facing the filler portion, constitutes a part of the first surface, and a surface of the second extension portion facing the filler portion, constitutes a part of the second surface;
viewed from inside the accommodation cavity outward along the direction perpendicular to the assembling direction of the first casing and the second casing, the first extension portion and the second extension portion partially overlap.

16. The electrical device according to claim 14, wherein an angle between the first surface and an outer wall surface of the first sidewall is an obtuse angle, and an angle between the second surface and an inner wall surface of the second sidewall is an obtuse angle; or, an angle between the first surface and an inner wall surface of the first sidewall is an obtuse angle, and an angle between the second surface and an outer wall surface of the second sidewall is an obtuse angle; or,
the first surface comprises a plurality of convex surfaces arranged continuously or discontinuously, the second surface comprises a plurality of convex surfaces arranged continuously or discontinuously.

17. The electrical device according to claim 14, wherein the first casing is a steel casing, and the second casing is an aluminum casing;
a wall thickness of the first sidewall is H₁, and a wall thickness of the second sidewall is H₂, wherein H₂>H₁, 30 μm≤H₁≤200 μm, and 150 μm≤H₂≤300 μm; and/or, 10% H₁≤H₂ H₁≤30% H₁.

18. The electrical device according to claim 14, wherein the electrode assembly is provided with a negative tab leading out a negative polarity and a positive tab leading out a positive polarity, the negative tab is connected to the first sidewall, and the positive tab is connected to the second sidewall.

19. The electrical device according to claim 14, wherein a minimum distance between the first sidewall and the second sidewall is D, wherein 7 μm≤D≤5000 μm.

20. The electrical device according to claim 19, wherein 40 μm≤D≤3000 μm.
